(19) United States
(12) Patent Application Publication
(10) Pub. No.: US 2025/0158045 A1
(43) Pub. Date: May 15, 2025

(54) SILICON COMPOSITE MATERIALS

(71) Applicant: Sicona Battery Technologies Pty Ltd,, North Wollongong, New South Wales (AU)

(72) Inventor: Geoffrey Edwards, North Wollongong, New South Wales (AU)

(21) Appl. No.: 18/837,444

(22) PCT Filed: Feb. 3, 2023
(86) PCT No.: PCT/AU2022/050071

§ 371 Date: Aug. 9, 2024

(30) Foreign Application Priority Data
Feb. 9, 2022 (AU) 2022900263

(51) Int. Cl. H01M 4/38; C01B 33/02; H01M 4/02; H01M 4/133; H01M 4/36; H01M 4/587; H01M 4/62; H01M 10/0525

(52) U.S. Cl. CPC H01M 4/386; C01B 33/02; H01M 4/133; H01M 4/366; H01M 4/587; H01M 4/625; H01M 10/0525; C01P 2004/80; C01P 2006/40; H01M 2004/021; H01M 2004/027

(57) ABSTRACT

The invention relates generally to a method for making a silicon composite comprising nanoscale silicon and carbon, the method comprising the steps of preparing a dispersion of silicon nanoparticles and the selected form/s of carbon; spray drying the dispersion to form essentially spherical silicon nanoparticles; heat treating the silicon nanoparticles to pyrolyse and/or burn off any polymers, and to strengthen the silicon nanoparticles; coating the silicon nanoparticles with carbon to form the Si:C composite; and optionally, adding additional elements such as lithium, magnesium, nitrogen and halogen gases to the composite, either during the heating step (c) or coating step (d) or during a subsequent heat treatment step. The invention relates further to composites made by such method, an anode or cathode made of such composite and a battery comprising the same.

This application claims priority from Australian Provisional Patent Application No. 2022900263 filed 9 Feb. 2022, the contents of which should be understood to be incorporated.

### FIELD OF THE INVENTION

The present invention relates to silicon composite materials for use as anode materials in lithium based batteries.

Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

With social progress, increasing energy demands are becoming more pronounced in fields such as electronics, renewable energy generation systems and electric vehicles. One means of addressing this every-increasing demand is via improved battery technologies.

Lithium-ion batteries (LIBs) are considered candidates for the increasing demand of portable electronic devices and electric and hybrid vehicles due to their high energy densities and stable cycle life.

Typical LIBs consist of a lithium metal cathode and an anode separated by a liquid electrolyte that transfers lithium between the two electrodes. Batteries provide power by discharging lithium from the anode to the cathode via the electrolyte. To date, most lithium-ion batteries use anodes made of graphite, layers of carbon sheets arranged in hexagonal patterns. The wide space between these layers provides the perfect location to store lithium atoms moving into and out of the anode as the battery charges and discharges. The maximum amount of lithium that can be stored in the anode determines the capacity of the battery, limiting how far a car can be driven before needing to be recharged. The capacity of traditional lithium-ion batteries with graphite anodes is around 370 mAh/g, enough to power a laptop, but insufficient for long travel.

Among various anode materials, silicon has attracted considerable attention because of its highest theoretical specific capacity (about 4200 mAh g⁻¹), which is ten times higher than that of conventional carbon anodes and satisfactory potentials for lithium insertion and extraction (<0.5 V versus Li/Li⁺).

Unfortunately, practical application of Si anodes is currently hampered by multiple challenges. The primary drawback is the huge volume change (˜300%) upon full lithiation and the resultant expansion/shrinkage stress during lithiation/delithiation, which may induce severe cracking of Si. This results in the formation of an unstable solid electrolyte interphase (SEI) on the Si surface, and causes lithium trapping in active Si material, consequently leading to irreversible fast capacity loss and low initial coulombic efficiency (CE). This creates problems with cycle life, and also swelling of electrodes which should be kept to less than about 20% for commercial cells.

Moreover, the slow lithium diffusion kinetics in Si (diffusion coefficient between 10⁻¹⁴ and 10⁻¹³ cm² s⁻¹) and low intrinsic electric conductivity of Si (10⁻¹ to 10⁻³ S cm⁻¹) also significantly affect the rate capability and full capacity utilisation of Si electrodes.

In order to improve cycle life, utilising nanosized silicon has been shown to produce acceptable cycle life since strain on expansion may be accommodated. However, this creates high surface area, leading to significant reaction with electrolyte, and low first cycle efficiencies. Nanosized silicon can also be somewhat expensive.

Silicon nanostructure materials, including nanotubes, nanowires, nanorods, nanosheets, porous and hollow or encapsulating Si particles with protective coatings, have been devoted to achieving improved structural and electrical performance.

Meanwhile, the preparation methods for these nanostructures (e.g., vapor-liquid-solid methods, magnetron sputtering and chemical vapor deposition) are generally complex technologies and multiple steps. Graphite and porous carbon are potential anode materials with relatively small volume change (e.g., ˜10.6% for graphite) during the lithiation-delithiation process and have excellent cycle stability and electronic conductivity. Compared with silicon, carbon materials have a similar nature, and they can combine closely with each other, so they are naturally selected as the substrate materials for dispersing silicon particles (i.e., dispersing carriers). Therefore, silicon-carbon composite anodes have been researched extensively because of their higher capacity, better electronic conductivity and cycle stability. However, problems of silicon-carbon anode materials, such as low first discharge efficiency, poor conductivity and poor cycling performance need to be overcome.

Previous work [Li, X., et al. “Mesoporous Silicon Sponge as an Anti-Pulverisation Structure for High-Performance Lithium-Ion Battery Anodes”, Nature Communications, 5:4105, 2014] has prevented this volume expansion by breaking up the silicon anode into many small nanoparticles embedded in another material to give them space to swell. However, this solution only generates more problems. The small Si nanoparticles that solve the expansion problem are vulnerable to irreversible reactions with liquid electrolyte seeping into the anode (known as the solid electrolyte interphase). These reactions hinder silicon's ability to take in lithium ions and reduce the overall lifetime of the battery. In addition, the small particles have poor conductivity, reducing the ability of the battery to provide enough current to power cars or other devices. So far, no anode design has been able to both limit volume expansion and prevent unwanted side effects such as electrolyte interactions and low conductivity.

Recently, a collaboration between the University of Waterloo and General Motors has developed a new method to protect the tiny silicon particles from the electrolyte while preserving their conductivity. The method creates a structural scaffolding around the silicon nanoparticles that allows lithium ions to intercalate but keeps the electrolyte out. The design combines three different materials: Si nanoparticles, graphite sheets with sulfur substituting for some carbon atoms (sulfur-doped graphene), and an organic polymer known as polyacrylonitrile (PAN). After mixing all the ingredients together, the silicon nanoparticles tend to covalently bond with the sulfur sites in the graphite. This strong interaction naturally creates a network of silicon particles bound to intermittent sulfur locations between graphite layers.

Heating the mixture slowly to about 450° C. develops a structural framework of PAN around and between the graphite layers. The ability of PAN to sneak its way through the entire graphene-Si structure shields the Si nanoparticles from the electrolyte while also providing a dense network of molecules along which electrons can travel. Thus, the anode design solves both the electrolyte and conductivity problems seen in previous anode designs. At the same time, the Si nanoparticles are happily stuck to the sulfur-doped graphene sheets, with plenty of room to expand between the graphite layers during lithium intercalation.

It is an object of the present invention to overcome or ameliorate at least one of the disadvantages of the prior art, or to provide a useful alternative.

The present invention relates generally to porous silicon composite particles to address one or more of the many problems with silicon. Without being bound by any one theory, the present inventors believe that when the Si to Carbon ratio is high (for example at least 75% silicon), the porous silicon composite particles can be held together by the small amount of carbon.

It is an object of an especially preferred form of the present invention to provide composite particles and methods of production that provide enhanced porosity with high silicon content relative to carbon, whilst preferably also being sealable with coatings of suitable thickness.

Although the invention will be described with reference to specific examples it will be appreciated by those skilled in the art that the invention may be embodied in many other forms.

### Definitions

In describing and defining the present invention, the following terminology will be used in accordance with the definitions set out below. It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising” and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of” and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50%, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

As used herein, the term “lithium ion battery” refers to any battery that uses a Li-ion to shuttle charge between an anode and cathode such as conventional lithium ion batteries, lithium metal batteries (such as a lithium zinc battery) and lithium sulfur batteries. A skilled addressee would understand that a dopant or additive could be present in the anode and/or cathode of the lithium ion battery while the Li-ion transfers the charge. Examples of a dopant or additive include zinc or sulfur.

The person skilled in the art would appreciate that the embodiments described herein are exemplary only and that the electrical characteristics of the present application may be configured in a variety of alternative arrangements without departing from the spirit or the scope of the invention.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practised or carried out in various ways.

### SUMMARY OF THE INVENTION

Applicant has surprisingly discovered that certain composite properties may be achieved using nanoparticles of silicon, various forms of carbon, and coatings of carbon. Such composite properties render the resultant coated Si:C nanoparticles amendable to use in lithium based batteries, for example, lithium ion batteries.

Furthermore, Applicant has surprisingly discovered methods for producing the composites that are comprised generally of low-cost processes.

Preferred embodiments of the present invention incorporate low-cost silicon and amounts of various allotropes of carbon that are optimised to achieve an advantageous combination of cost and performance in the resultant LIB.

According to a first aspect of the present invention there is provided a silicon composite comprising nanoscale silicon and carbon in a weight ratio of between about 75:25 and about 99:1 (silicon:carbon), and having a volume fraction of porosity between about 20 and about 70%.

In an embodiment, the weight ratio of the nanoscale silicon to carbon is between about 90:10 to about 96:4.

In an embodiment, the volume fraction of porosity is between about 50% to about 60%.

In an embodiment, the porosity of the composite accommodates swelling up to about 300% during the lithiation-delithiation process.

In an embodiment, the carbon is a fibrous form of carbon, such as carbon nanotubes (CNTs) and/or thin nanoplates, such as graphene or graphene oxide or reduced graphene oxide, or combinations thereof.

In an embodiment, the composite further comprises carbon produced by pyrolysis of a polymeric precursor such as sugars, including glucose, sucrose, fructose and the like.

In an embodiment, the composite is sealed with a carbon coating of appropriate thickness.

In an embodiment, the coating reduces the available (effective) surface area of the Si:C particles by between about 50 and about 80%.

In an embodiment, the coating is less than about 500 nm thick.

In an embodiment, the composite is for use in a lithium based battery, in particular, lithium ion battery.

In an embodiment, the composite is for use as an anode in a lithium based battery, in particular, lithium ion battery.

In an embodiment, the composite is for use as a cathode in a lithium based battery, in particular, lithium ion battery.

According to a second aspect of the present invention there is provided an anode for a lithium ion battery comprising a silicon composite according to the first aspect of the present invention.

According to a third aspect of the present invention there is provided a cathode for a lithium ion battery comprising a silicon composite according to the first aspect of the present invention.

According to a fourth aspect of the present invention there is provided a half cell for a lithium ion battery comprising an anode according to the second aspect of the present invention, binder and a conducting additive in a weight ratio of composite to binder to conducting additive of about 8:1:1, 9:0.5:0.5, 95:0.2:0.3 or 97:1:2.

According to a fifth aspect of the present invention there is provided a half cell for a lithium ion battery comprising a cathode according to the third aspect of the present invention, binder and a conducting additive in a weight ratio of composite to binder to conducting additive of about 8:1:1, 9:0.5:0.5, 95:0.2:0.3 or 97:1:2.

In certain embodiments, the conducting additive is graphite. In some embodiments, the graphite may be natural graphite, synthetic graphite, amorphous graphite, calcined petroleum coke, crystalline flake graphite, natural flake graphite, surface enhanced flake graphite, expandable graphite, purified flake graphite, purified crystalline flake graphite, purified petroleum coke, purified synthetic graphite, purified-vein graphite, synthetic graphite, primary artificial graphite, secondary artificial graphite, spherical natural graphite, vein graphite and combinations thereof. In some embodiments, the conducting additive is in the form of a synthetic final anode product. In some embodiments, the conducting additive is a graphite anode.

In some embodiments, the conductive additive is a conductive carbon. In some embodiments, the conductive carbon is selected from the group consisting of carbon black (such as super P® or Imerys C45), activated carbon, carbon nanotubes and derivatives thereof; graphene and derivates thereof; and combinations thereof.

In some embodiments, the binder is selected from the group consisting of at least one of a linear polymer, a conductive polymer, a self-healing polymer, a rubber polymer and combinations thereof.

In an embodiment, the one or more linear polymers are selected from a hydroxyl group, an amine group or a carboxyl group of linear polymers.

In an embodiment, the one or more conductive polymers are selected from an imino group or a sulfonic acid group of conductive polymers.

In an embodiment, the one or more self-healing polymers are selected from a urea group of self-healing polymers.

In an embodiment, the one or more linear polymers are selected from the group consisting of sodium carboxymethyl cellulose (CMC), polyacrylic acid (PAA), lithium polyacrylic acid (LiPAA), polyvinyl alcohol (PVA), sodium alginate (SA), and chitosan (CS).

In an embodiment, the one or more conductive polymers are selected from the group consisting of polyaniline (PANI), sodium poly[9,9-bis(3-propanoate)fluorine](PFCOONa), poly(1-pyrenemethyl methacrylate-co-methacrylic acid) (PPyMAA), polypyrrole (PPY) and 3,4-ethylenedioxythiophene/polystyrene-4-sulfonate (PEDOT:PSS).

In an embodiment, the one or more self-healing polymers are selected from the group consisting of urea-pyrimidinone (UPy), urea-oligo-amidoamine (UOAA), dopamine methacrylamide (DMA) and dopamine (DA). In an embodiment, the one or more self-healing polymers is urea-oligo-amidoamine (UOAA).

In an embodiment, the one or more rubber polymers are selected from the group consisting of styrene butadiene rubber (SBR), neoprene, nitrile rubber, butyl silicone rubber and polysulfide rubber.

In an embodiment, the binder is carboxylmethyl cellulose (CMC)/styrene-butadiene rubber (SBR) and the conducting additive is Imerys C45 carbon black.

In an embodiment, the counter electrode is lithium metal.

According to a sixth aspect of the present invention there is provided a lithium ion battery comprising an anode according to the second aspect of the present invention, a cathode, an electrolyte and a separator.

According to a seventh aspect of the present invention there is provided a lithium ion battery comprising a cathode according to the seventh aspect of the present invention, an anode, an electrolyte and a separator.

In an embodiment, the electrolyte is selected from metals or transition metals with sulfates, sulfites (including bisulfates), phosphates, hexafluorophosphate, carbonates, bicarbonates, hydroxides, permanganates, chromates, dichromates, oxalates, formates, acetates, benzoates, halides, chlorites, perchlorites and hypochlorites and the like (e.g., perfluorates, hypobromites, etc.), acids, and the like and mixtures thereof. In an especially preferred embodiment, the electrolyte is ammonium sulfate, lithium hexafluorophosphate, iron sulfate or a mixture thereof. In another embodiment, the electrolyte is sulfuric acid or nitric acid. Preferably, the electrolyte is iron sulfate, lithium hexafluorophosphate or ammonium sulfate.

In further embodiment, the electrolyte is selected from sulfides, phosphides, phenolates, superoxides, peroxides, oxides, silicates, sulfones, thiocyanates, thiosulfates, selenates, triiodides, azides, cyanides, cyanates, borates, fulminates, arsenates, vanadates, antimonates and the like.

In an embodiment, the cathode comprises lead, lead alloys and combinations thereof. In an embodiment, the cathode comprises platinum and graphitic electrodes, various grades of stainless steel, ferrous alloys, other transition metal alloys and the like.

In an embodiment, the process further comprises the use of a separator which is a permeable membrane typically placed between a cathode or anode or both. Preferably, the permeable membrane is a neutrally-charged permeable membrane, an anion exchange membrane, or a cation exchange membrane. More preferably, the permeable membrane is selected from asbestos cloth, cellulose, glass cloth, filter cloth, glass cloth impregnated with silica gel, porous sintered stainless steel, vinyl chloride acrylonitrile, polysulfone, polyethersulfone (PES), polycarbonate, polytetrafluoroethylene, polyethylene terephthalate (PET), polyolefin, polyethylene, popropylene, porous poly(methyl methacrylate)-grafted and/or siloxane grafted polyethylene, polyvinylidene fluoride (PVDF) and combinations thereof. Alternatively, the membrane may comprise sintered metal and non-metal materials such as ceramics.

In an embodiment, the separator has a molecular weight cut-off (MWCO) of less than about 1 million Da. Preferably, the separator has a molecular weight cut-off (MWCO) of between about 10 kDa, and about 0.5 kDa. More preferably, the separator has a molecular weight cut-off (MWCO) of about 3.5 kDa. In one embodiment, the separator has an air permeability of between 0.1 and 100 L/min/dm² at 200 Pa. Preferably, the separator has an air permeability of between 1 and 50 L/min/dm² at 200 Pa. More preferably, the separator has an air permeability of between 2 and 30 L/min/dm² at 200 Pa.

According to an eighth aspect of the present invention there is provided a method for making a silicon composite comprising nanoscale silicon and carbon, the method comprising the steps of:
(a) preparing a dispersion of silicon nanoparticles and the selected form/s of carbon;
(b) spray drying the dispersion to form essentially spherical, micrometre-sized composite particles;
(c) heat treating the composite particles to pyrolyse and/or burn off any polymers, and to strengthen the composite particles;
(d) coating the composite particles with carbon to form the Si:C composite; and
(e) optionally, adding additional elements such as lithium, magnesium, nitrogen and halogen gases to the composite, either during the heating step (c) or coating step (d) or during a subsequent heat treatment step.

According to a ninth aspect of the present invention there is provided a method for making a silicon composite comprising nanoscale silicon and carbon, the method comprising the steps of:
(a) preparing a dispersion of silicon nanoparticles by milling in water and retaining the mixture of silicon and water;
(b) optionally, preparing a separate dispersion of selected form/s of carbon in water, optionally comprising one or more surfactants;
(c) adding the carbon dispersion and optional surfactant mixture (or carbon in non-dispersed form) to the silicon-water dispersion;
(d) dispersing the resultant mixture;
(e) spray drying the resultant dispersed Si:C mixture to form essentially spherical particles;
(f) heat treating the essentially spherical particles to pyrolyse and/or burn off any polymers, and to strengthen the spherical Si:C particles;
(g) coating the heat treated spherical Si:C particles with carbon using a chemical vapor deposition process to form a carbon-coated Si:C composite; and
(h) optionally, adding additional elements such as lithium, magnesium, nitrogen and halogen gases to the carbon-coated Si:C composite, either during mixing step (c) or dispersion step (d) or during subsequent heat treatment.

In an embodiment of the eighth or ninth aspects, the selected form/s of carbon comprise carbon nanotubes (CNTs) and/or thin nanoplates, such as graphene or graphene oxide or reduced graphene oxide and combinations thereof. In preferred embodiments, the selected form of carbon are carbon nanotubes, preferably single walled carbon nanotubes (SWCNTs).

In an embodiment of the eighth or ninth aspects, the weight ratio of the nanoscale silicon to carbon is between about 90:10 to about 96:4.

In an embodiment of ninth aspect, the surfactant/s are non-ionic.

In an embodiment of the eighth or ninth aspects, the carbon further comprises carbon produced by pyrolysis of a polymeric precursor such as sugars, including glucose, sucrose, fructose and the like.

In an embodiment of the eighth or ninth aspects, the volume fraction of porosity in the particles prior to coating is between about 50% to about 60%.

In an embodiment of the eighth or ninth aspects, the composite is sealed with a carbon coating of appropriate thickness.

In an embodiment of the eighth or ninth aspects, the coating reduces the available (effective) surface area of the Si:C particles by between about 50 and about 80%.

In an embodiment of the eighth or ninth aspects, the thickness of the coatings is less than about 500 nm.

According to a tenth aspect of the present invention there is provided a silicon composite comprising nanoscale silicon and carbon, when made by a process according to the eighth aspect of the present invention.

According to an eleventh aspect of the present invention there is provided a carbon-coated silicon composite comprising nanoscale silicon and carbon, when made by a process according to the ninth aspect of the present invention.

According to a twelfth aspect of the present invention there is provided an anode for a lithium ion battery comprising a silicon composite according to the tenth aspect or a carbon-coated silicon composite according to the eleventh aspect of the present invention.

According to a thirteenth aspect of the present invention there is provided a half cell for a lithium ion battery comprising an anode according to the twelfth aspect of the present invention, binder and a conducting additive in a weight ratio of composite to binder to conducting additive of about 8:1:1, 9:0.5:0.5, 95:0.2:0.3 or 97:1:2.

According to an fourteenth aspect of the present invention there is provided a lithium ion battery comprising an anode according to the twelfth aspect of the present invention, a cathode, an electrolyte and a separator.

According to a fifteenth aspect of the present invention there is provided a silicon composite particle, comprising at least 75% silicon with respect to carbon, comprising at least 50% pores, wherein the carbon is comprised of carbon nanotubes.

According to a sixteenth aspect of the present invention there is provided a silicon composite material, comprising at least 50% pores, where the amount of silicon in the material is greater than 90%.

### BRIEF DESCRIPTION OF THE DRAWINGS

A preferred embodiment of the invention will now be described, by way of example only, with reference to the accompanying drawings in which:

FIG. 1 shows scanning electron microscope (SEM) images of uncoated particles of the composite of the present invention; 8.0 kV; scale 1 μm (a) and 100 nm (b). FIG. 1 shows scanning electron microscope images of the particles. The porous carbon network (1) contains silicon nanoparticles (2) that are very well distributed, i.e., most nanoparticles are not in contact with one another.

FIG. 2 shows scanning electron microscope (SEM) images of uncoated and coated particles of the composite material of the present invention; 8.0 kV; scale 1 μm (a) and (b). FIG. 2 shows scanning electron microscope images of the particles before and after coating. The coating seals at least 90% of the surface. In similar experiments, the coating was found to reduce the surface area from ˜100 m²/g to about 5 m²/g, showing that the Si nanoparticles are effectively sealed by the coatings.

FIG. 3 shows porosity (pore size distribution) of the particles from Example 1 before coating. Porosity, as measured by mercury porosimetry, was 54%.

FIG. 4 shows a typical coin-on-coin lithium-ion battery having an anode comprising Si:C composite produced by Example 1.

### DETAILED DESCRIPTION OF A PREFERRED EMBODIMENT

Porous particles comprising silicon and carbon appeal as desirable anode materials since the pores may absorb the swelling of the silicon internally and hence reduce swelling in the electrode itself. A high level of porosity is desirable as this enables a higher level of silicon to be incorporated whilst still allowing for swelling.

Carbon may fulfil several roles in the inventive Si:C composite. Firstly, it can separate the silicon particles so that the particles do not impinge upon each other when swelling. A carbon network can also add strength and resilience to the composite particles and provide a strong network for conduction of electrons and lithium ions. However, the gravimetric and volumetric capacity of carbon is much less than silicon. Hence it is desirable to have low amounts of carbon, whilst still allowing the carbon network to fulfil its various functions.

Carbon nanotubes are a good potential source of carbon, since they are able to provide networks with a very low volume fraction of carbon due to their very small diameter. Similarly, graphene and/or graphite nanoplatelets are very thin and can also produce networks with low volume fractions.

Typically, a sufficient amount of carbon is required in a Si:C composite as it is understood that carbon provides the porosity in the Si:C composite. The amount of carbon required was typically greater than 30% to achieve sufficient porosity. The present inventors have surprisingly found that a high silicon content Si:C composite can still provide sufficient porosity of greater than 50%, in particular, when less than 30% carbon and more preferably less than 10% carbon is used.

For a commercially-relevant product, it is necessary to have a high level of porosity. In some embodiments, the volume fraction (V_{f}) of porosity to V_{f} silicon is about 2 to allow for expansion of the silicon internally. In other embodiments, the ratio of V_{f} porosity to V_{f} silicon is about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or about 4.0.

Preferably, the amount of carbon should be minimised whilst still providing a sufficiently strong conducting network.

Finally, the highly porous structure should be sealable with a coating that is sufficiently thin so that gravimetric and volumetric capacities are not significantly reduced by the coating. By sealing the particles, the liquid electrolyte cannot directly access the surface of the silicon and hence, silicon-electrolyte reactions are minimised. However, highly porous structures would not normally be expected to be good for coating. Also, coating is heavily dependent upon nucleation and growth of the coating and therefore upon the structure of the surface. For nanoscale materials, such structures can be very difficult if not impossible to predict in terms of outcomes for coating processes.

The inventors have discovered that suitable Si:C composites may be prepared using a method comprised of the following steps:
(a) Preparing a dispersion of silicon nanoparticles and the selected form/s of carbon;
(b) Spray drying the dispersion to form essentially spherical composite particles;
(c) Heat treating the silicon nanoparticles to pyrolyse and/or burn off any polymers, and to strengthen the composite particles;
(d) Coating the composite particles with carbon to form the Si:C composite; and
(e) Optionally, adding additional elements to the composite, either during the heating step (c) or coating step (d) or during a subsequent heat treatment step, that can increase first cycle efficiency and/or increase cycle life. Examples include lithium, magnesium, nitrogen and may further include halogen gases.

A preferred embodiment of the method of the present invention comprises the following steps.
(a) Preparing a dispersion of silicon nanoparticles by milling in water and retaining the mixture of silicon and water;
(b) Optionally, preparing a separate dispersion of selected form/s of carbon in water, optionally comprising one or more surfactants;
(c) Adding the carbon dispersion and optional surfactant mixture (or carbon in non-dispersed form) to the silicon-water dispersion;
(d) Dispersing the resultant mixture;
(e) Spray drying the resultant dispersed Si:C mixture to form essentially spherical particles;
(f) Heat treating the essentially spherical particles to pyrolyse and/or burn off any polymers, and to strengthen the spherical Si:C particles;
(g) Coating the heat treated spherical Si:C particles with carbon using a chemical vapor deposition process to form a carbon-coated Si:C composite; and
(h) Optionally, adding additional elements to the carbon-coated Si:C composite, either during mixing step (c) or dispersion step (d) or during subsequent heat treatment, that can increase first cycle efficiency and/or increase cycle life. Examples include lithium, magnesium, nitrogen and halogen gases.

In this embodiment, cost is reduced compared to current state-of-the-art by (i) milling in water instead of organic solvents, (ii) the use of milled metallurgical silicon to form silicon nanoparticles and (iii) avoiding drying of the silicon nanoparticles to maintain separation of the nanoparticle silicon (i.e., discrete nanoparticles of silicon) to maintain high rates of porosity. If the silicon dries, the composite can collapse before pyrolysis.

In preferred embodiments, the porous Si:C composite has a high level of porosity, which enables a high level of silicon to be incorporated whilst still allowing for swelling upon full lithiation and the resultant expansion/shrinkage stress during lithiation/delithiation.

Preferably the volume fraction of porosity in the particles is greater than 30%, or greater than 40%, or greater than 50%, or about 60%. In other embodiments, the volume fraction of porosity is greater than about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or about 70%.

In some embodiments the volume fraction of porosity is about double the volume fraction of silicon. In other embodiments, the volume fraction of porosity is about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4 or about 3.5-times the volume fraction of silicon.

The porosity of the Si:C composite accommodates swelling up to about 300%. In an embodiment, the swelling is up to about 350, 340, 330, 320, 310, 300, 290, 280, 270, 260, 250, 240, 230, 220, 210, 200, 190, 180, 170, 160, 150, 140, 130, 120, 110 or about 100%.

In preferred embodiments, the ratio of silicon to carbon is maximised whilst achieving the preferred volume fractions of porosity quoted above. Silicon has much higher gravimetric capacity and volumetric capacity than carbon. Therefore, it is desirable for both gravimetric capacity and volumetric capacity that the ratio of silicon to carbon is maximised.

The ratio of silicon to carbon is an important feature of the present invention. In an embodiment, the ratio may be between about 75:25 to about 96:4, between about 80:20 to about 96:4, between about 90:10 to about 96:4 or between about 92:8 to about 96:4 on a weight basis. Mixtures of various forms of carbon may give desired performance and cost. In other embodiments, the ratio of silicon to carbon is about 75:25, 76:24, 77:23, 78:22, 79:21, 80:20, 81:19, 82:18, 83:17, 84:16, 87:13, 88:12, 89:11, 90:10, 91:9, 92:8, 93:7, 94:6, 95:5 or 96:4 w/w.

In preferred embodiments, the carbon may be provided by fibrous forms of carbon, such as carbon nanotubes (CNTs), preferably SWCNTs. CNTs of low diameters have the advantage of being able to provide a mechanically stable framework with a low volume fraction of carbon. Very thin nanoplates, such as graphene or graphene oxide or reduced graphene oxide can also help achieve a framework with a low volume fraction of carbon. In other embodiments, the carbon may be a mixture of carbon forms, e.g., CNTs interspersed with graphene platelets. In preferred embodiments, the carbon is provided as carbon nanotubes, preferably single walled carbon nanotubes.

In some embodiments, the carbon network may be improved by small amounts of carbon produced by pyrolysis of a polymeric precursor. Examples of polymeric precursors are sugars, including glucose, sucrose, fructose and the like, and pitch. Such material may improve the connectivity of the carbon network, providing resilience and/or improved Li ion conductivity and/or improved electron conductivity.

The amount of carbon produced in this way may be less than 20%, or less than 10%, or less than 5% of the uncoated composite weight. In other embodiments, the amount of carbon produced in this way may be less than about 30, 29, 28, 27, 26, 25, 24, 23, 22, 21, 20, 19, 18, 17, 16, 15, 14, 13, 12, 11, 10, 9, 8, 7, 6, 5, 4, 3, 2 or less than about 1% of the uncoated composite weight.

In certain embodiments, the nanoscale silicon has an average particle size of between about 50 nm and about 500 nm. In certain embodiments, the nanoscale silicon has an average particle size of between about 50 nm and about 450 nm. In certain embodiments, the nanoscale silicon has an average particle size of between about 50 nm and about 400 nm. In certain embodiments, the nanoscale silicon has an average particle size of between about 50 nm and about 350 nm. In certain embodiments, the nanoscale silicon has an average particle size of between about 50 nm and about 300 nm. In certain embodiments, the nanoscale silicon has an average particle size of between about 50 nm and about 250 nm. In certain embodiments, the nanoscale silicon has an average particle size of between about 50 nm and about 200 nm. In certain embodiments, the nanoscale silicon has an average particle size of between about 50 nm and about 150 nm. In certain embodiments, the nanoscale silicon has an average particle size of between about 80 nm and about 120 nm. In certain embodiments, the nanoscale silicon has an average particle size of about 100 nm.

As would be appreciated by a skilled addressee, any suitable surfactant can be used in the present invention. In certain embodiments, the co-surfactant is selected from the group consisting of a non-ionic surfactant, ionic surfactant or zwitterionic surfactant. In some embodiments, the surfactant is a polar solvent. In some embodiments, the co-surfactant comprises an alcohol group. In preferred embodiments, the surfactant is an alcohol (—OH). In some embodiments, the co-surfactant comprises a primary alcohol. In some embodiments, the surfactant comprises a secondary alcohol.

In one embodiment, the surfactant comprises a functional group selected from the group consisting of sulfate, sulfonate, phosphate, carboxylate, amine, ammonium, alcohol, ether and combinations thereof.

In one embodiment, the anionic co-surfactant is selected from the group consisting of ammonium lauryl sulfate, sodium lauryl sulfate, sodium laureth sulfate, sodium myreth sulfate, dioctyl sodium sulfosuccinate, perfluorooctanesulfonate, perfluorobutanesulfonate, sodium lauroyl sarcosinate, perflurononanoate, ferfluorooctanoate, sodium stearate, stearate, oleate, linoleate, linoleneate, eicosapentaenoate, docosahexaenoate and combinations thereof; a salt, solvate, dimer, isomer, chelate, or enantiomer thereof.

In one embodiment, the cationic co-surfactant is selected from the group consisting of cetrimonium bromide, cetylpyridinium chloride, benzalkonium chloride, benzethonium chloride, dimethyldioctadecylammonium chloride, phosphatidylcholine, dioctadecyldimethylammonium bromide and combinations thereof; a salt, solvate, dimer, isomer, chelate, or enantiomer thereof.

In one embodiment, the zwitterionic surfactant is selected from the group consisting of sultaines and betaines. In one embodiment, the zwitterionic surfactant is selected from the group consisting of hydroxysultaine, (3-[(3-cholamidopropyl)dimethylammonio]-1-propanesulfonate), cocoamidopropyl betaine, cocamidopropyl hydroxysultaine, phosphatidylserine, phosphatidylethanolamine, phosphatidylcholine, sphingomyelins; lauryldimethylamine oxide, myristamine oxide; and combinations thereof.

In one embodiment, the non-ionic surfactant is selected from the group consisting of narrow range ethoxylates, octaethylene glycol monododecyl ether, pentaethylene glycol monododecyl ether, nonoxynol, triton X-100, polyethoxylated tallow amine, cocamide monoethanolamine, cocamide diethanolamine, glycerol monostearate, monolaurin, polysorbate 20, decyl glucoside, a polar solvent and combinations thereof.

In preferred embodiments, particles having the above attributes of porosity, silicon-to-carbon ratio and carbon types/ratios may be essentially sealed with a coating of appropriate thickness. By essentially sealed, Applicant means that the coating reduces the available (effective) surface area of the Si:C particles by at least 50%, preferably at least 80%. In other embodiments, the coating reduces the available (effective) surface area of the Si:C particles by at least about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or at least about 90%.

The coatings may be less than about 500 nm thick, or less than about 400 nm thick, or less than about 300 nm thick, or less than about 200 nm thick. In preferred embodiments, the coatings may be less than about 600, 580, 560, 540, 520, 500, 480, 460, 440, 420, 400, 380, 360, 340, 320, 300, 280, 260, 240, 220, 200, 180, 160, 140, 120 or less than about 100 nm thick. It will be appreciated that the coatings vary in thickness and thus the quoted thickness is an average thickness across a selection of coated Si:C nanoparticles. Larger particles may have a thicker coating since the relative volume fraction is less. However larger particles may result in poor rate performance. It may be appreciated that the particle size and coating thickness may vary and be optimised for different applications. In an embodiment, the coating thickness is approximately the same as the spacing between the particles in the composite.

Lithium ions enter the Si:C composite by solid state diffusion. In an embodiment, an additive such as glucose and/or sucrose enables the solid state diffusion of the lithium ions into the Si:C composite.

In preferred embodiments, the composite utilises low-cost forms of silicon. In a preferred embodiment, the silicon is in the form of angular nanoparticles that have been produced using a grinding process. In other preferred embodiments, the silicon nanoparticles have been milled in water and the silicon nanoparticles have an oxide formed on the surface. However, in certain embodiments, the silicon nanoparticles can be milled without or without being oxidized or part-oxidised. In other embodiments, the silicon nanoparticles are formed by chemical vapor deposition (CVD), which can have varying levels of oxidation or no oxidation. Oxidised or part-oxidised silicon nanoparticles can be treated to remove the oxidation before use in the present invention. Current state of the art processes prefer silicon with minimal oxide layer. However, Applicant has surprisingly found that good performance may still be achieved using oxidised or part-oxidised silicon nanoparticles. In some embodiments, the Applicant has surprisingly found that using oxidized or part-oxidised silicon nanoparticles provided high specific capacity of the Si:C composite of the present invention. This is because conventionally, the presence of oxygen (present as an oxide layer on the silicon) would be expected to reduce the specific capacity of the Si:C composite.

In some embodiments, the oxide layer may be altered by introduction of elements such as lithium and/or magnesium and/or nitrogen. These layers may improve lithium ion diffusion, and may also react with the oxide, thereby reducing reaction with electrolyte during initial charging and discharging, thus aiding first cycle efficiency.

The Applicant has surprisingly found unexpectedly high first cycle efficiency (low coulombic efficiency loss with the first cycle) using Si:C composites having high silicon content. In some embodiments, the lithium ion battery comprising the Si:C composite as described herein has a first cycle efficiency of greater than about 75%. In some embodiments, the lithium ion battery comprising the Si:C composite has a first cycle efficiency of greater than about 80%, greater than about 85% or greater than about 90%. In some embodiments, the lithium ion battery comprising the Si:C composite has a first cycle efficiency of between about 75% and about 95%, between about 80% and about 95%, between about 80% and about 90%, between about 85% and about 90%. In some embodiments, the lithium ion battery has a first cycle efficiency of 88%.

The Applicant has also surprisingly found that the inventive Si:C composite of the present invention has a high specific capacity. In some embodiments, the Si:C composite has a de-lithiation capacity of greater than about 2500 mAh/g, greater than about 2700 mAh/g, greater than about 2800 mAh/g, greater than about 2900 mAh/g, greater than about 3000 mAh/g. In some embodiments, the Si:C composite has a de-lithiation capacity of between about 2500 mAh/g to about 3500 mAh/g, between about 2700 mAh/g to about 3300 mAh/g, between about 2900 mAh/g to about 3200 mAh/g, between about 3000 mAh/g to about 3200 mAh/g. In some embodiments, the Si:C composite has a de-lithiation capacity of about 3100 mAh/g.

In the method of the present invention, the dispersion may be spray dried to form particles of about 10 μm in diameter. In other embodiments, the dispersion may be spray dried to form particles of about 1, 2, 3, 4, 5, 6, 7, 8, 9, 10, 11, 12, 13, 14, 15, 16, 17 18, 19, 20, 21, 22, 23, 24 or about 25 μm in diameter. This diameter may be varied using known spray drying parameters to achieve a desired particle size. As would be appreciated by those skilled in the art, particle diameters can be adjusted to give different performance in terms of energy density and power.

As would be appreciated by a skilled addressee, any suitable temperature can be used for the heat treatment step of the present invention. In some embodiments, the heat treatment is performed at a temperature of greater than about 700° C., greater than about 750° C., greater than about 800° C., greater than about 850° C. or greater than about 950° C. In some embodiments, the heat treatment is performed at a temperature of between about 700° C. to about 1000° C., between about 750° C. to about 950° C. or between about 800° C. to about 900° C. In some embodiments, the heat treatment is performed at a temperature of about 850° C.

The method of the present invention may optionally utilise a step that passivates sites that are active toward electrolytes in cells. Such sites can reduce first cycle efficiencies and cycle life. Examples of such steps include high temperature treatments, introduction of halogen gases during high temperature treatments, and introduction of lithium via evaporation of lithium metal, either during the pyrolysis step or a chemical vapor deposition (CVD) or atomic layer deposition (ALD) step.

### Example 1

Silicon nanoparticles were produced by grinding silicon particles in a water-based medium using a high-speed ball mill. Carbon nanotubes were dispersed in water using a suitable surfactant such as a non-ionic surfactant. The silicon nanoparticle/water mixture, the carbon nanotube/water mixture, and glucose were then dispersed in an aqueous solution, using suitable surfactants. This mixture was then spray dried to give particles with average size about 18 μm diameter. The particles were then pyrolysed in a reducing H₂/Ar atmosphere at about 850° C. The following properties were obtained upon pyrolysis of the surfactant and glucose.

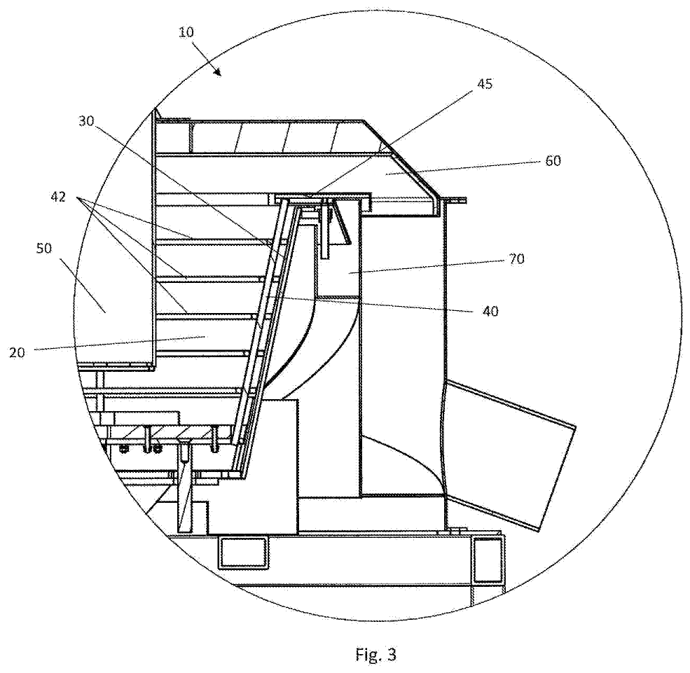

The ratio of silicon-to-carbon nanotubes was between about 90:10 to about 96:4. Very high porosity was maintained even though the carbon content was low (unexpected as typically carbon provides the porosity of the Si:C composite). The present inventors found that Si:C composite with 92:8 Si:C ratio delivered 54% porosity. In this example, single walled carbon nanotubes (SWCNTs) was used without any other source of carbon. Porosity was measured by mercury porosimetry, and supported by SEM (FIG. 3).

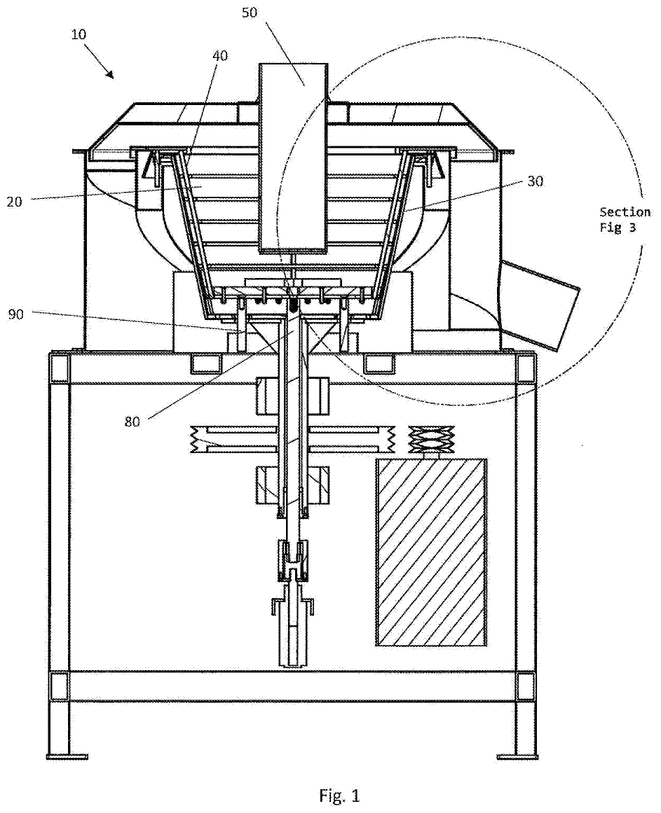

FIG. 1 shows scanning electron microscope images of the particles. The porous carbon network (1) contains silicon nanoparticles (2) that are well distributed, i.e., most nanoparticles are not in contact with one another.

A carbon coating was deposited on the particles using fluidised bed chemical vapor deposition (CVD) and propane gas at about 1000° C. and with a propane ratio of 32% with respect to the carrier gas of 5% H₂ in argon. Scanning electron microscopy showed that the thickness of the coating ranged between about 200 nm and about 300 nm.

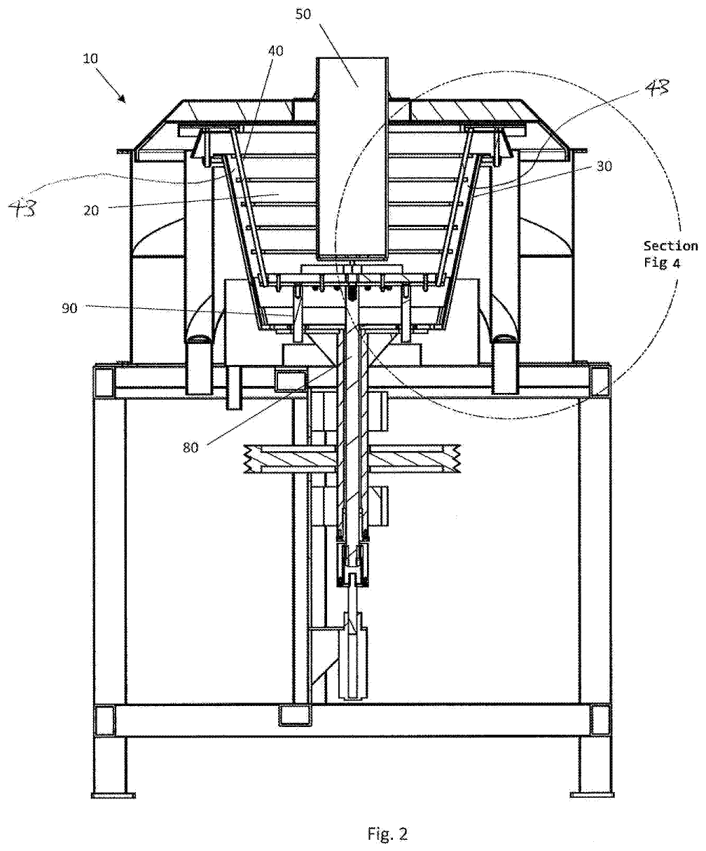

FIG. 2 shows scanning electron microscope images of the particles before (a) and after (b) coating. It can be seen that the coating seals at least 90% of the surface. In similar experiments, the coating was found to reduce the surface area from ˜100 m²/g to about 5 m²/g, showing that the particles are effectively sealed by the coatings.

Half cells were made using the composite material and carboxylmethyl cellulose (CMC)/styrene-butadiene rubber (SBR) binder and using Imerys C45 carbon black as conducting additive. The ratio of composite to binder to C45 was 8:1:1. Lithium metal was the counter electrode. The composite yielded a capacity of ˜3100 mAh/g and a first cycle efficiency of ˜88% (96:4 Si:C composite).

### Comparative Example 1

The procedure in Example 1 was used, however glucose was not added and a coating step was not performed. The composite yielded a capacity of only ˜240 mAh/g with a first cycle efficiency of ˜70%. Applicant postulates that without the glucose, lithium ions were unable to properly diffuse through the carbon solid, thus reducing capacity.

### Comparative Example 2

The procedure in Example 1 was used, however a coating was not applied. The capacity was ˜1000 mAh/g. However, the first cycle efficiency was only ˜60%. This shows that the coating was necessary to provide reasonable first cycle efficiencies.

### Example 2 Lithium-Ion Battery (LIB)

Battery electrodes can be formed using Si:C composite as described for example in Example 1 to provide coin cell batteries.

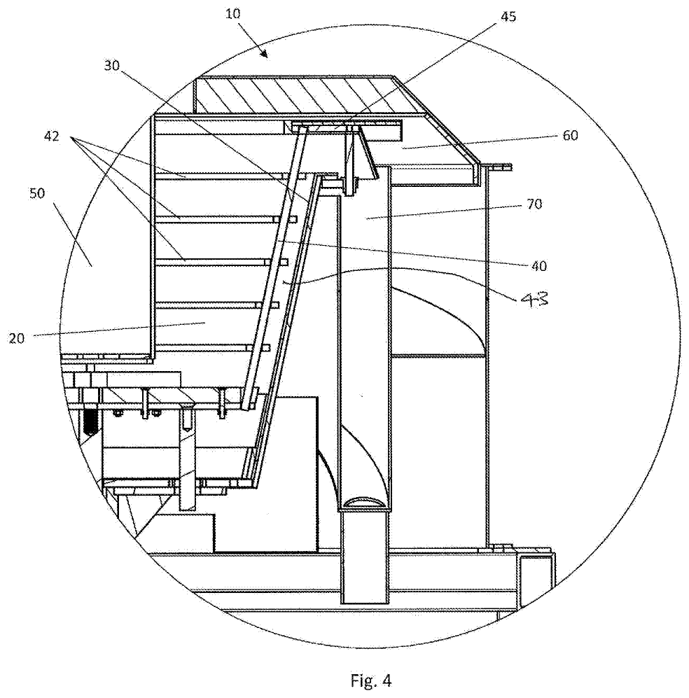

Referring to FIG. 4, there is illustrated an example of lithium-ion battery 100 (i.e. lithium-ion cell) including an anode comprising nano-silicon particles produced by the methods disclosed herein. FIG. 4 illustrates a coin-on-coin type lithium-ion battery 100 having a first component 112 and a second component 114, which are constructed of a conductive material and can act as electrical contacts. However, it should be noted that the battery 100 can be constructed according to any lithium-ion battery configuration as is known in the art. Within, or attached to, first component 112 is an anode 116 comprising Si:C composites produced by the method of the present invention, and within, or attached to, second component 114 is a cathode 120, with separator 118 positioned between anode 116 and cathode 120.

An insulator 122 ensures that anode 116 is only in conductive connection with the first component 112 and cathode 120 is only in conductive connection with the second component 114, whereby conductive contact with both the first component 112 and the second component 114 closes an electrical circuit and allows current to flow due to the electrochemical reactions at anode 116 and cathode 120. The coin-on-coin lithium-ion battery configuration as well as other electrode and component configurations are well known in the art and the present inventive anode can be readily configured to any type of lithium-ion battery as would be apparent to a person skilled in the art.

In an example lithium-ion battery configuration using an electrolyte, various electrolytes can be used. An example non-limiting electrolyte includes 1.15 M LiPF6 in a mixture of ethylene carbonate (EC)/ethyl methyl carbonate (EMC)/ethyl propionate (EP)/fluoroethylene carbonate (FEC) in a weight ratio of 27:35:27:10, with additive agents such as, for example, propylene sulfate (PS) and adiponitrile (AND).

The coin cell was characterised and the present inventors found very high specific capacity when tested (96% Si 4% C, Si:C material) having a 3,100 mAh/g de-lithiation capacity. The present inventors also found unexpectedly high first cycle efficiency (low coulombic efficiency loss with the 1st cycle) of 88%. This was surprising as water based processing of the silicon and SWCNTs with the use of surfactants (including binder comprising carboxymethylcellulose) did not cause significant adverse effects on the capacity of the silicon as would be expected due to introduction of oxygen onto the silicon (by forming an oxide layer on the silicon) thereby reducing the capacity.

Although the invention has been described with reference to specific examples it will be appreciated by those skilled in the art that the invention may be embodied in many other forms.

1. A silicon composite comprising nanoscale silicon and carbon in a weight ratio of between about 75:25 and about 99:1 (silicon:carbon), and having a volume fraction of porosity between about 20 and about 70%.

2. The composite according to claim 1, wherein the weight ratio of the nanoscale silicon to carbon is between about 90:10 to about 96:4.

3. The composite according to claim 1, wherein the volume fraction of porosity is between about 50% to about 60%.

4. The composite according to claim 1, wherein the porosity of the composite accommodates swelling up to about 300% during the lithiation-delithiation process.

5. The composite according to claim 1, wherein the carbon is a fibrous form of carbon.

6. (canceled)

7. The composite according to claim 1, which is sealed with a carbon coating of appropriate thickness.

8. The composite according to claim 7, wherein the coating reduces the available (effective) surface area of the Si:C particles by between about 50 and about 80%.

9. (canceled)

10. The composite according to claim 1, for use as an anode or cathode in a lithium based battery.

11. An anode or cathode for a lithium based battery comprising a silicon composite according to claim 1.

12. A half cell for a lithium ion battery comprising an anode or cathode according to claim 449, binder and a conducting additive in a weight ratio of composite to binder to conducting additive of about 8:1:1, about 9:0.5:0.5, about 95:0.2:0.3 or about 97:1:2.

13. (canceled)

14. (canceled)

15. A lithium ion battery comprising an anode according to claim 11, a cathode, an electrolyte and a separator.

16. A method for making a silicon composite comprising nanoscale silicon and carbon according to claim 1, the method comprising the steps of:
(a) preparing a dispersion of silicon nanoparticles and the selected form/s of carbon;
(b) spray drying the dispersion to form essentially spherical, micrometre-sized composite particles;
(c) heat treating the composite particles to pyrolyse and/or burn off any polymers, and to strengthen the composite particles;
(d) coating the composite particles with carbon to form the Si:C composite; and
(e) optionally, adding additional elements such as lithium, magnesium, nitrogen and halogen gases to the composite, either during the heating step (c) or coating step (d) or during a subsequent heat treatment step.

17. The method for making a silicon composite comprising nanoscale silicon and carbon according to claim 1, the method comprising the steps of:
(a) preparing a dispersion of silicon nanoparticles by milling in water and retaining the mixture of silicon and water;
(b) optionally, preparing a separate dispersion of selected form/s of carbon in water, optionally comprising one or more surfactants;
(c) adding the carbon dispersion and optional surfactant mixture (or carbon in non-dispersed form) to the silicon-water dispersion;
(d) dispersing the resultant mixture;
(e) spray drying the resultant dispersed Si:C mixture to form essentially spherical particles;
(f) heat treating the essentially spherical particles to pyrolyse and/or burn off any polymers, and to strengthen the spherical Si:C particles;
(g) coating the heat treated spherical Si:C particles with carbon using a chemical vapor deposition process to form a carbon-coated Si:C composite; and
(h) optionally, adding additional elements adding additional elements such as lithium, magnesium, nitrogen and halogen gases to the composite to the carbon-coated Si:C composite, either during mixing step (c) or dispersion step (d) or during subsequent heat treatment.

18. The method according to claim 12, wherein the selected form/s of carbon comprise carbon nanotubes (CNTs) and/or thin nanoplates.

19. The method according to claim 12, wherein the weight ratio of the nanoscale silicon to carbon is between about 90:10 and about 96:4.

20. (canceled)

21. (canceled)

22. The method according to claim 12, wherein the volume fraction of porosity is between about 50% and about 60%.

23. The method according to claim 6, wherein the composite is sealed with a carbon coating of appropriate thickness.

24. The method according to claim 17, wherein the coating reduces the available (effective) surface area of the Si:C particles by between about 50 and about 80%.

25. (canceled)

26. (canceled)

27. (canceled)

28. (canceled)

29. (canceled)

30. (canceled)

31. A silicon composite particle, comprising at least 75% silicon with respect to carbon, comprising at least 50% pores, wherein the carbon is comprised of carbon nanotubes.

32. A silicon composite material, comprising at least 50% pores, where the amount of silicon in the material is greater than 90%.
